(19) United States
(12) Patent Application Publication
(10) Pub. No.: US 2008/0063567 A1
(43) Pub. Date: Mar. 13, 2008

(54) Analyzer with automatically actuated movable closure of pipetting openings

(75) Inventors: Gottlieb Schacher, Kriens (CH); Raphael Gut, Luzern (CH)

Correspondence Address: DINSMORE & SHOHL, LLP;ONE DAYTON CENTRE, ONE SOUTH MAIN STREET, SUITE 1300, DAYTON, OH, 45402, US

(73) Assignee: Roche Diagnostics Operations, Inc., Indianapolis, IN (US)

(21) Appl. No.: 11/897,849

(22) Filed: Aug. 31, 2007

(30) Foreign Application Priority Data
Sep. 11, 2006 (EP) 06018932.1

(51) Int. Cl. B01J 19/00

(52) U.S. Cl. 422/68.1

(57) ABSTRACT

A clinical chemistry analytical apparatus for automatically analyzing a plurality of biological fluids samples is disclosed. The apparatus provides a movable cover having a pipetting opening which allows insertion of a pipetting needle therethrough, a closure mechanism which in a first state closes the pipetting opening and in a second state leaves it open, a conveyor automatically transporting a reagent container to a pipetting position, at which an opening of the reagent container is aligned with the pipetting opening, and an actuation mechanism which automatically brings the closure mechanism into the second state before introducing the pipetting needle through the pipetting opening and which brings the closure mechanism into the first state after withdrawal of the pipetting needle from the pipetting opening. The actuation mechanism is adapted to actuate the closure mechanism by a displacement of a transport device that moves the pipetting needle to and from the pipetting position.

### FIELD OF THE INVENTION

The present invention relates generally to clinical chemistry analytical apparatuses, and in particular to a clinical chemistry analytical apparatus for automatically analyzing a plurality of samples of biological fluids, wherein aliquots of the samples are mixed with aliquots of selected reagent liquids in reaction cuvettes for forming sample-reagent-mixtures contained in a plurality of reaction cuvettes.

### BACKGROUND OF THE INVENTION

An analytical apparatus of the above mentioned kind contains a plurality of reagent containers each of which contains a reagent in liquid form. Each of the reagent containers has an opening at its upper end. The operation of the apparatus includes pipetting operations which include insertion of a pipetting needle of an automatic pipetting unit through the upper opening of a reagent container for aspirating an aliquot of reagent liquid and dispensing of this aliquot to a selected reaction cuvette.

Since the reagent containers should be kept open in order to facilitate the above mentioned pipetting operation, and since the reagent containers are refrigerated at a constant temperature to prevent deterioration of the reagents and to ensure extended stability thereof, there is some loss of reagents by evaporation and there is some amount of water vapor condensation in the reagent containers and in the interior of the housing where the reagent containers are lodged. These are undesirable effects which affects the reliability of the measurements carried out with the analytical apparatus. The latter effects are particularly important when the temperature of the environment of the apparatus is relatively high.

### SUMMARY OF THE INVENTION

It is against the above background that the present invention provides an analytical apparatus which eliminates or at least substantially reduces the amount of reagents losses by evaporation and the amount of water vapor condensation in the reagent containers.

In one embodiment, a clinical chemistry analytical apparatus for automatically analyzing a plurality of samples of biological fluids, wherein aliquots of the samples are mixed with aliquots of selected reagent liquids in reaction cuvettes for forming sample-reagent-mixtures contained in a plurality of reaction cuvettes is disclosed. The apparatus comprises an array of reagent containers and an array of reaction cuvettes. Each of the reagent containers and reaction cuvettes have an opening at its upper end. An automatic pipetting unit having a pipetting needle for taking an aliquot of reagent from one of the reagent containers and for delivering the aliquot into one of the reaction cuvettes is provided. In one embodiment, the automatic pipetting unit has a transport device for moving the pipetting needle to at least one pipetting position. The transport device is adapted for moving the pipetting needle along a first axis which extends in vertical direction and along a second axis which is perpendicular to the first axis. In one embodiment, a movable cover covering a chamber in which reagent containers are stored is also provided. The cover has a closed position at which it closes the chamber, and at least one pipetting opening which allows insertion of the pipetting needle therethrough, the center of the at least one pipetting opening being located at the at least one pipetting position. In one embodiment, a closure mechanism is mounted on the cover, and is adapted for being brought into a first state and into a second state. In one embodiment, the at least one pipetting opening being closed when the closure mechanism is in the first state, and the at least one pipetting opening being open when the closure mechanism is in the second state. In one embodiment, also provided is a conveyor configured to automatically transport each of the reagent containers to a pipetting position, at which the opening at the upper end of the reagent container is aligned with the at least one pipetting opening of the cover. In one embodiment, an actuation mechanism is provided and configured to automatically actuate the closure mechanism to bring the closure mechanism into the second state before introducing the pipetting needle through the at least one pipetting opening and to automatically actuate the closure mechanism to bring the closure mechanism into the first state after withdrawal of the pipetting needle from the at least one pipetting opening, wherein the actuation mechanism is adapted for being actuated by a displacement of the transport device associated with the motion thereof that moves the pipetting needle along the second axis to the at least one pipetting position, and respectively away from the at least one pipetting position.

These and other features and advantages of the present invention will be apparent from the following detailed description provided hereinafter with reference to the accompanying drawings.

### BRIEF DESCRIPTION OF THE DRAWINGS

The subject invention will now be described in terms of various embodiments with reference to the accompanying drawings in which like references indicate similar elements. These embodiments are set forth to aid the understanding of the invention, but are not to be construed as limiting.

FIG. 1 shows an overall perspective view of an apparatus according to the invention.

FIG. 2 shows a perspective view of the apparatus of FIG. 1 without cover.

FIG. 3 shows a perspective view of reagent container assembly installed in the analyzer of FIG. 1, but without its cover and without any reagent container in it.

FIG. 4 shows an enlarged view of a portion of FIG. 3.

FIG. 5 shows a top view of the conveyor part of the analyzer shown in FIG. 2 and in particular reagent container assembly before it is loaded with reagent containers.

FIG. 6 shows a cross-sectional view taken along a plane I-I in FIG. 5.

FIG. 7 shows a perspective view of a single reagent container.

FIG. 8 shows a perspective view of the apparatus of FIGS. 1 and 2 without the cover of its central part. FIG. 8 shows in particular the location of a first embodiment of a movable closure of the pipetting openings in that cover.

FIG. 9 shows a perspective upside-down view of the cover of the central part of the analyzer of FIGS. 1 and 8. FIG. 9 shows in particular the location of the movable closure represented in FIG. 8.

FIG. 10 shows a perspective view of the movable closure represented in FIGS. 8 and 9.

FIG. 11 shows a perspective exploded view of the components of the movable closure represented in FIG. 10.

FIG. 12 shows a perspective view of a part of the movable closure represented in FIGS. 10 and 11. FIG. 12 shows in particular a movable slide element which carries magnets and which is part of the movable closure.

FIG. 13 shows a top view of the part of the movable closure shown by FIG. 12 with the slide element in a first position at which the slide element closes the pipetting openings of the cover of the central part of the apparatus of FIGS. 1, 2 and 8.

FIG. 14 shows a top view of the part of the movable closure shown by FIG. 12 with the slide element in a second position at which openings of the slide element are aligned with the pipetting openings of the cover of the central part of the apparatus of FIGS. 1, 2 and 8. FIG. 14 thus shows the position of the slide element at which the pipetting openings are open and allow insertion of a pipetting needle therethrough.

FIG. 15 shows a partial perspective view of the transport device which transports the pipetting needle and which carries a magnet for moving the slide element shown in FIGS. 12 to 14. FIG. 15 shows in particular that the latter magnet is attached to a plate which is part of the transport device which transports the pipetting needle.

FIGS. 16 to 22 illustrate various positions of the magnet attached to the transport device of the pipetting needle with respect to the magnets attached to the slide element of the movable closure of the cover of the central part of the apparatus of FIGS. 1, 2 and 8.

FIG. 23 shows a bottom plan view of a part of an embodiment of a movable closure of the pipetting openings in the cover of the central part of the analyzer of FIGS. 1 and 8. FIG. 23 shows in particular slide elements which are part of that movable closure and which are in a position in which they close the pipetting openings in the cover of the central part of the analyzer of FIGS. 1 and 8.

FIG. 24 shows a top plan view of the cover of the central part of the analyzer of FIGS. 1 and 8 and in particular pins which are part of the slide elements shown in FIG. 23.

FIG. 25 shows a perspective view of the cover shown in FIG. 24

FIG. 26 shows a perspective view of a part of the transport device which transports the pipetting needle. FIG. 26 shows in particular that the latter transport device carries a cam which is attached to a plate which is part of the transport device which transports the pipetting needle.

FIG. 27 shows a perspective view which illustrates how the cam represented in FIG. 26 cooperates with the pins of the slide elements shown in FIG. 23 for displacing those elements to positions where they leave the pipetting openings open.

FIG. 28 shows a bottom plan view of a part of the embodiment of a movable closure represented in FIG. 23 with the slide elements in positions where they leave the pipetting openings open.

### DETAILED DESCRIPTION OF THE INVENTION

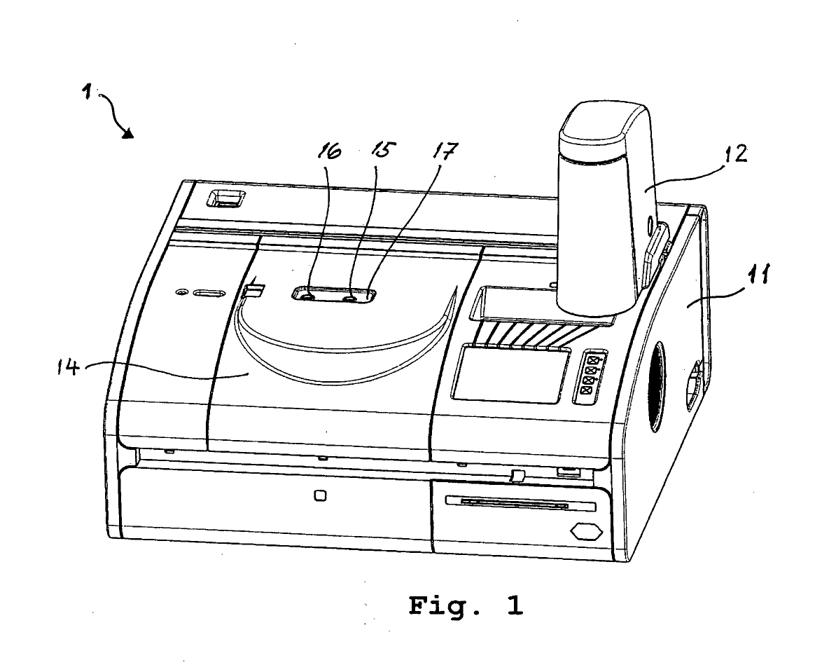

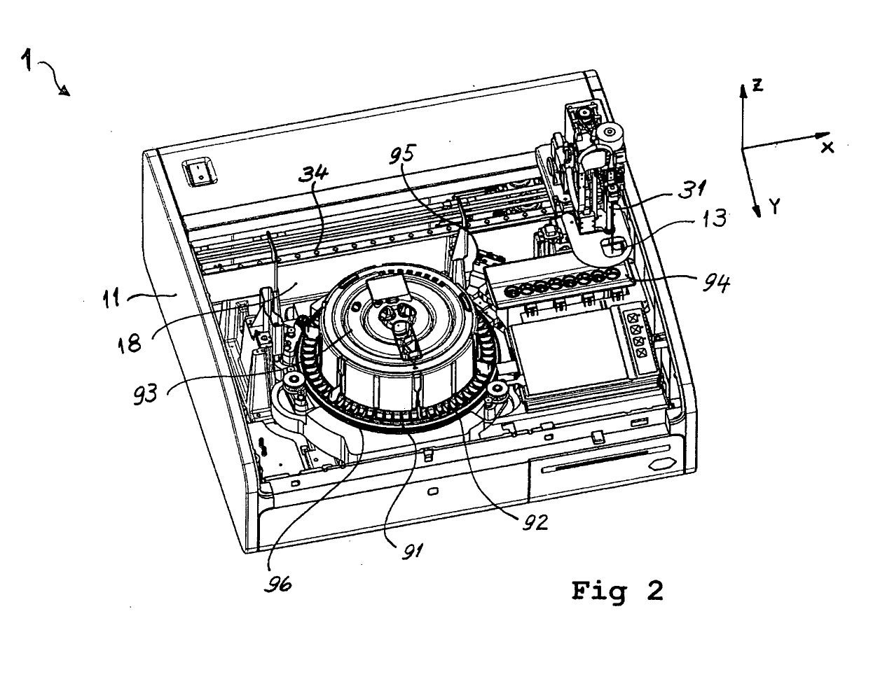

FIG. 1 shows an overall perspective view of an apparatus according to the invention, e.g. a clinical-chemistry analyzer, generally indicated by symbol 1, for automatically analyzing a plurality of samples of biological fluids, wherein aliquots of the samples are mixed with aliquots of selected reagent liquids in reaction cuvettes for forming sample-reagent-mixtures contained in a plurality of reaction cuvettes. FIG. 2 shows a perspective view of the apparatus of FIG. 1 without covers which are part of housing 11.

The analyzer 1 shown in FIGS. 1 and 2 has a housing 11 and an automatic pipetting unit 12.

An array of reagent containers and an array of reaction cuvettes described hereinafter are arranged in the interior of housing 11. Each of the reagent containers and reaction cuvettes has an opening at its upper end.

Automatic pipetting unit 12 has a pipetting needle 13 (shown in FIG. 2) for taking an aliquot of reagent from one of the reagent containers and for delivering the aliquot into one of the reaction cuvettes. Automatic pipetting unit 12 comprises a transport device 31 for moving pipetting needle 13 to at least one pipetting position. Transport device 31 is adapted for moving pipetting needle 13 along a first axis which extends in vertical direction and along a second axis which is perpendicular to the first axis. In the example described hereinafter with reference to FIG. 2, transport device 31 is mounted on a rail 34 which extends along the X-axis shown in FIG. 2. Transport device 31 is moved by suitable drive means, e.g. a conventional motor, servomotor or any other suitable electromechanical device(s), along rail 34 and is thus able to move pipetting needle 13 along an axis parallel to the X-axis. Transport device 31 comprises drive means, e.g. a conventional motor, servomotor or any other suitable electromechanical device(s), for moving pipetting needle 13 along an axis parallel to the Z-axis shown in FIG. 2. In the apparatus shown in FIGS. 1, 2 and 8, transport device 31 brings pipetting needle to predetermined pipetting positions which are aligned along one and the same axis and this axis is parallel to the X-axis represented in FIG. 2.

Housing 11 has a movable cover 14 which is e.g. a hinged cover. Cover 14 covers a chamber 18 in housing 11 and has a closed position at which it closes that chamber. In one embodiment cover 14 is an air-tight closure of that chamber. The reagent container assembly 93 and the reagent containers in that assembly are stored in chamber 18.

Cover 14 has at least one pipetting opening which allows insertion of pipetting needle 13 of the automatic pipetting unit therethrough. In the embodiment shown by FIG. 1, cover 14 has pipetting openings 15 and 16. The center of each of pipetting openings 15 and 16 is located at a corresponding pipetting position of the pipetting needle. A closure mechanism 17 for selectively closing and opening pipetting openings 15 and 16 is mounted on cover 14.

In one embodiment, pipetting openings are just large enough to allow insertion of pipetting needle 13 therethrough.

Closure mechanism 17 is adapted for being brought into a first state and into a second state. Pipetting openings 15 and 16 are closed when closure mechanism 17 is in the first state. Pipetting openings 15, 16 are open when closure mechanism 17 is in the second state.

The apparatus shown in FIGS. 1 and 2 further comprises an actuation mechanism configured to automatically bring closure mechanism 17 into its second state before introducing the pipetting needle 13 through at least one of the pipetting openings 15, 16, and also bring automatically the closure mechanism into its first state after withdrawal of pipetting needle 13 from the pipetting opening.

In one embodiment, the actuation mechanism for automatically actuating closure mechanism 17 is adapted for being actuated by a displacement of transport device 31 associated with the motion thereof that moves pipetting needle 13 along the second axis to the at least one pipetting position, respectively away from the at least one pipetting position.

In another embodiment, the actuation mechanism for automatically actuating closure mechanism 17 brings the closure mechanism into its second state immediately before introducing the pipetting needle 13 through a pipetting opening 15, 16, and brings the closure mechanism 17 into its first state immediately after withdrawal of pipetting needle 13 from pipetting opening 15, 16.

The apparatus shown in FIGS. 1 and 2 further comprises a rotatable conveyor 91 for automatically transporting each of the reagent containers to a pipetting position, at which the opening at the upper end of the reagent container is aligned with a pipetting opening of cover 14.

As shown by FIG. 2, rotatable conveyor 91 conveys reaction cuvettes 92 inserted in corresponding cavities of conveyor 91 along a circular path and also rotates a reagent container assembly 93 arranged in the central part of conveyor 91, so that reagent containers in reagent container assembly 93 are also transported along a circular path. Conveyor 91 is rotated by means of conveyor driving means 96 driven by, e.g. at least one conventional motor, servomotor, or any other suitable electromechanical device(s).

A sample tube area 94 and a photometer 95 are located adjacent to conveyor 91.

Reaction cuvettes 92 inserted in the above mentioned cavities of conveyor 91 are held by a cuvette holder. Such a cuvette holder holds a plurality of reaction cuvettes 92. A cuvette holder and reaction cuvettes 92 held by a cuvette holder form a cuvette array. The analyzer comprises at least one such array. Usually reaction cuvettes of a plurality of such cuvette arrays are installed in corresponding cavities of conveyor 91. In the example shown by FIG. 2, conveyor 91 has cavities for receiving 60 reaction cuvettes distributed in 6 cuvette arrays each array having 10 reaction cuvettes.

FIG. 3 shows a perspective view of reagent container assembly 93 installed in the analyzer, but without its cover and without any reagent container in it.

Reagent container assembly 93 is connected with conveyor 91, so that when conveyor 91 is rotated reagent container assembly 93 rotates with conveyor 91.

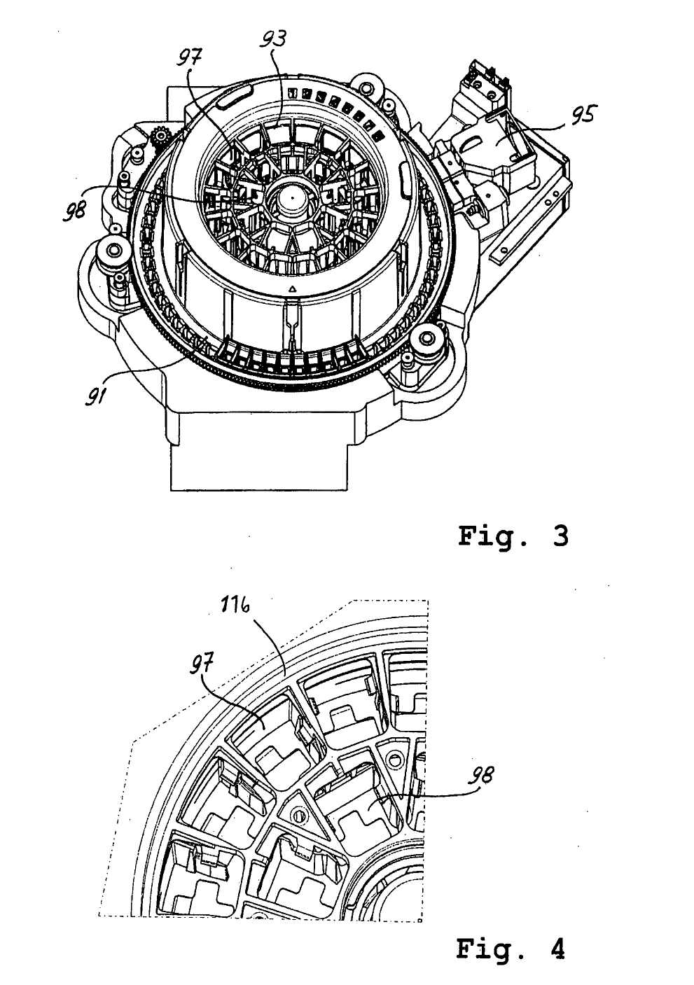

FIG. 4 shows an enlarged view of a portion of FIG. 3. As can be appreciated from FIGS. 3 and 4 reagent container assembly 93 comprises a housing 116 having two concentric arrays of chambers adapted for receiving reagent containers, a first circular array of chambers 97 and a second circular array of chambers 98.

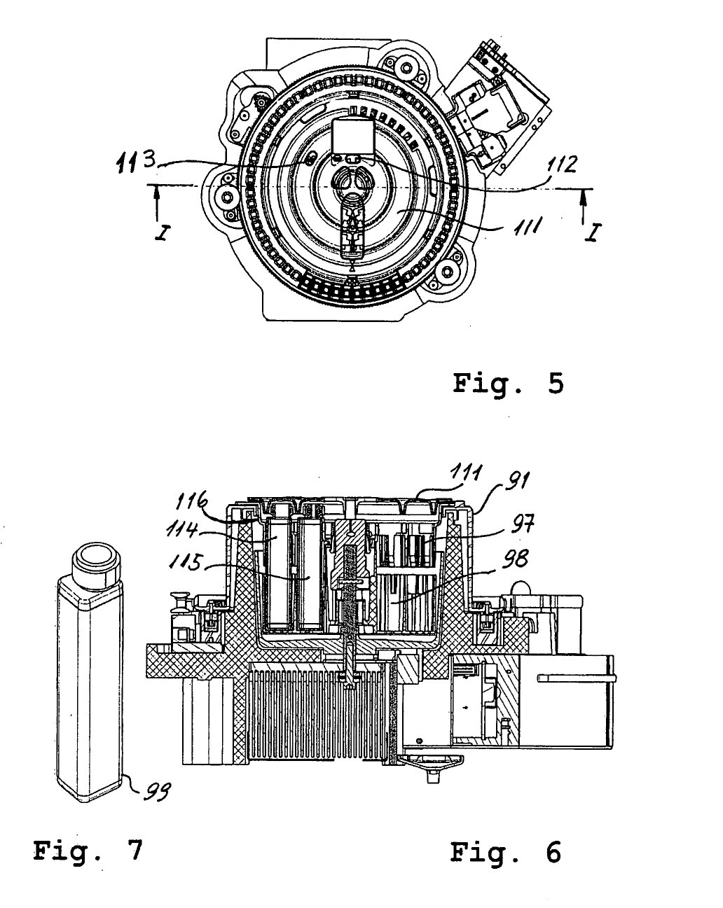

FIG. 5 shows a top view of the conveyor part of the analyzer 1 shown in FIG. 1 and in particular of reagent container assembly 93 before it is loaded with reagent containers.

FIG. 6 shows a cross-sectional view taken along a plane I-I in FIG. 5.

As shown in FIGS. 5 and 6 reagent container assembly 93 comprises a cover 111 and a housing 116 having the shape of a bucket. Cover 111 has openings 112 and 113 through which pipetting needle 13 is introduced into reagent containers lodged in the above mentioned circular arrays of chambers 97 and 98.

FIG. 7 shows a perspective view of a reagent container 99.

As shown by FIGS. 3 and 4, reagent container assembly 93 contains concentric arrays of chambers 97, 98 each of which is adapted for receiving a reagent container 99 shown by FIG. 7. Each of reagent containers 99 contains a specific reagent in liquid form. Each reagent container 99 carries an automatically readable label (not shown), e.g. a barcode label, which identifies the specific reagent contained in the reagent container.

FIG. 8 shows a perspective view of the analyzer 1 of FIGS. 1 and 2 without cover 14 of its central part. FIG. 8 shows in particular the location of an embodiment of a closure mechanism 17 of the pipetting openings in cover 14 and the location of a thermal insulation plate 19 which is arranged between the inner surface of cover 14 and closure mechanism 17.

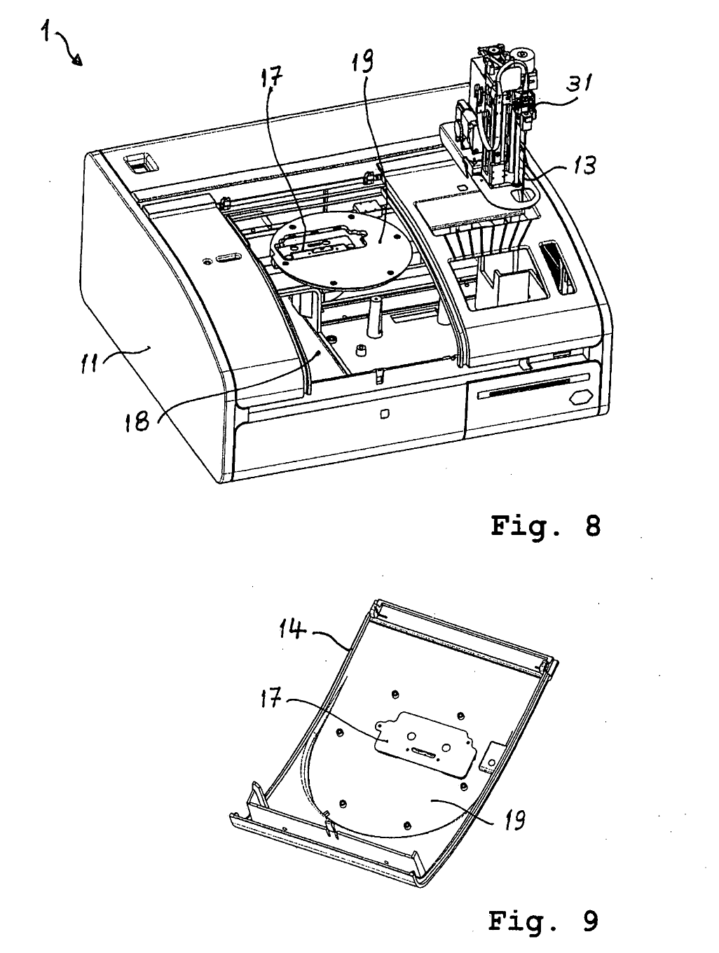

FIG. 9 shows a perspective upside-down view of cover 14. FIG. 9 shows in particular closure mechanism 17 and thermal insulation plate 19 represented in FIG. 8 mounted on the inner surface of cover 14.

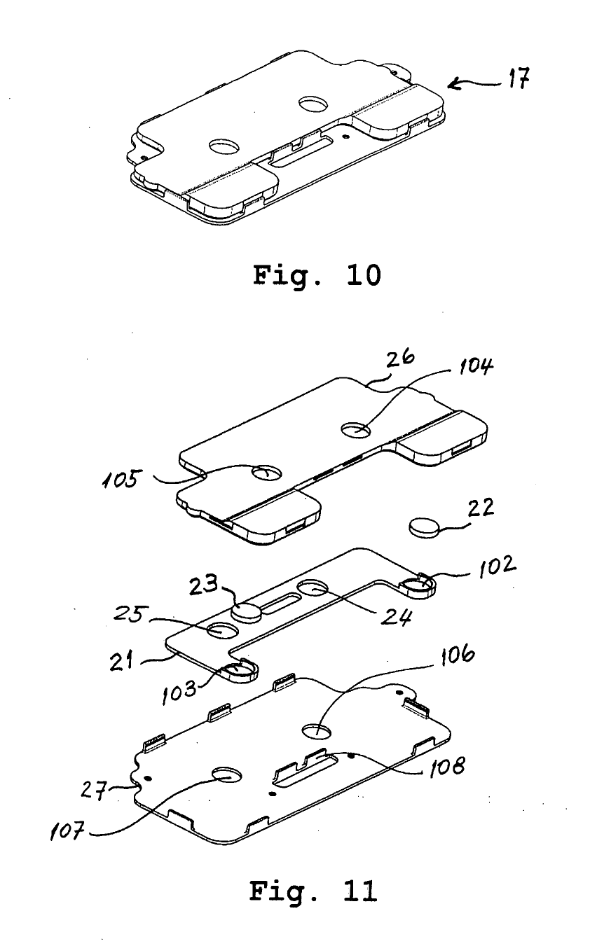

FIG. 10 shows a perspective view of closure mechanism 17 in FIGS. 8 and 9.

FIG. 11 shows a perspective exploded view of the components of closure mechanism 17 in FIG. 10.

As shown by FIG. 11, in one embodiment of the closure mechanism 17, the actuation mechanism in one embodiment comprises a slide element 21 which has a body and openings 24 and 25 in that body. These openings allows insertion of pipetting needle 13 therethrough when slide element 21 is in a position at which openings 24 and 25 of slide element are aligned with pipetting openings 15, 16 of cover 14.

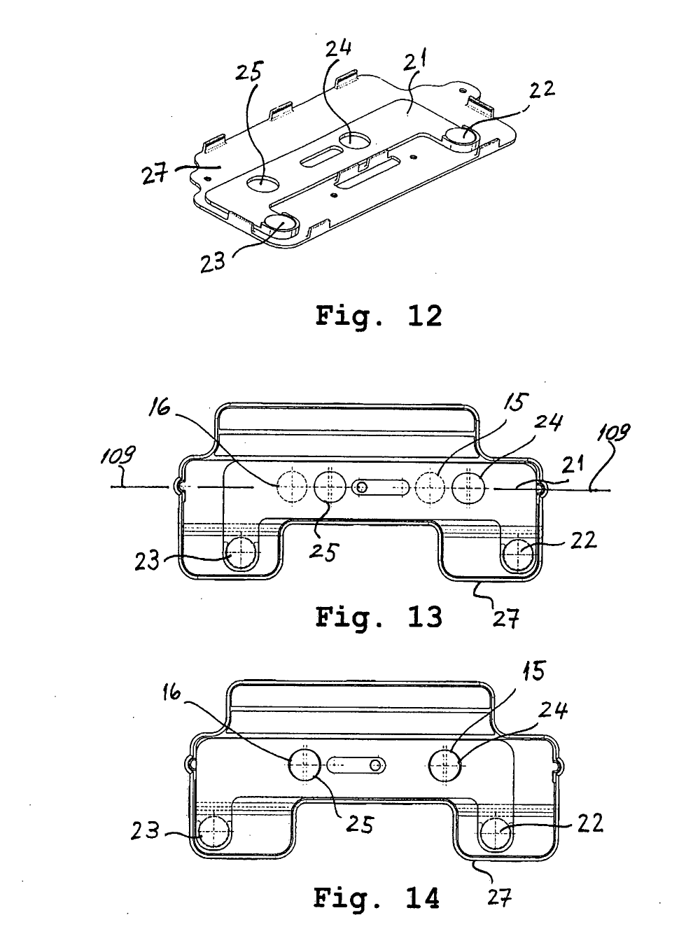

Before closure mechanism 17 is assembled, permanent magnets 22, 23 in FIG. 11 are positioned in pockets 102, 103 of slide element 21 and are attached thereto by suitable means, e.g. by a suitable adhesive. FIG. 12 shows the position of permanent magnets 22, 23 when these are attached to slide element 21 and this element is placed on lower plate 27.

The embodiment of the closure mechanism 17 represented in FIGS. 10 and 11 further comprises a housing for slide element 21 and this housing comprises an upper plate 26 and a lower plate 27. Upper plate 26 has openings 104, 105 which are aligned with pipetting openings 15 respectively 16 when closure mechanism 17 is mounted on cover 14. Lower plate 27 has openings 106, 107 which are aligned with openings 104, 105 of upper plate 26 and thereby also aligned with pipetting openings 15 respectively 16 of cover 14 when closure, mechanism 17 is assembled and mounted on cover 14, e.g. by means of screws.

Lower plate 27 has a guide element 108 which guides slide element 21 when it is displaced along a longitudinal axis 109 which passes through the centers of openings 24 and 25 of slide element 21.

FIG. 13 shows a top view of the part of closure mechanism 17 shown by FIG. 12 with slide element 21 in a first position at which the body of slide element 21 closes pipetting openings 15, 16 of cover 14 of the central part of the apparatus of FIGS. 1, 2 and 8. The position of slide element 21 shown by FIG. 13 corresponds to a first state of closure mechanism 17.

FIG. 14 shows a top view of the part of the movable closure shown by FIG. 12 with slide element 21 in a second position at which openings 24, 25 of slide element 21 are aligned with pipetting openings 15, 16 of cover 14 of the central part of the apparatus of FIGS. 1, 2 and 8. FIG. 14 thus shows the position of slide element 21 at which pipetting openings 15, 16 are open and allow insertion of pipetting needle 13 therethrough. The position of slide element 21 shown by FIG. 14 corresponds to a second state of closure mechanism 17.

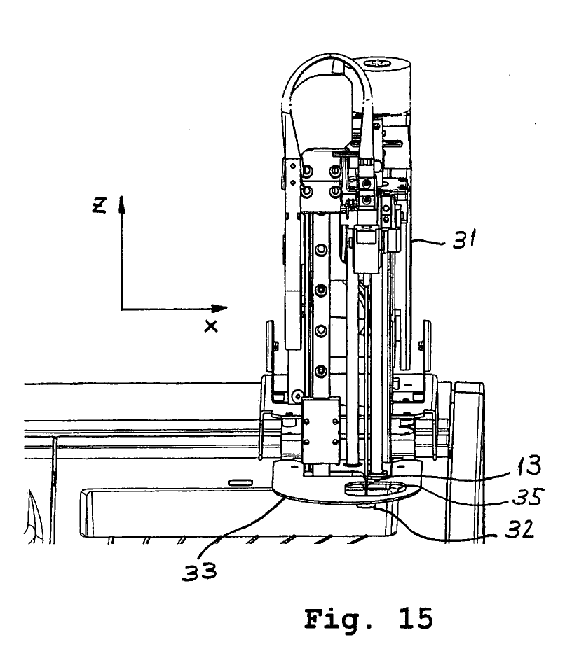

FIG. 15 shows a partial perspective view of transport device 31 shown in FIGS. 2 and 8 which transports pipetting needle 13 along an axis parallel to the X-axis represented in FIG. 15.

Transport device 31 comprises a lower plate 33 which has an opening 35 which allows passage of pipetting needle 13 therethrough. A permanent magnet 32 is attached by suitable means to the outer surface of lower plate 33. For this purpose permanent magnet 32 is e.g. arranged in a magnet holder which is mounted by means of screws on lower plate 33.

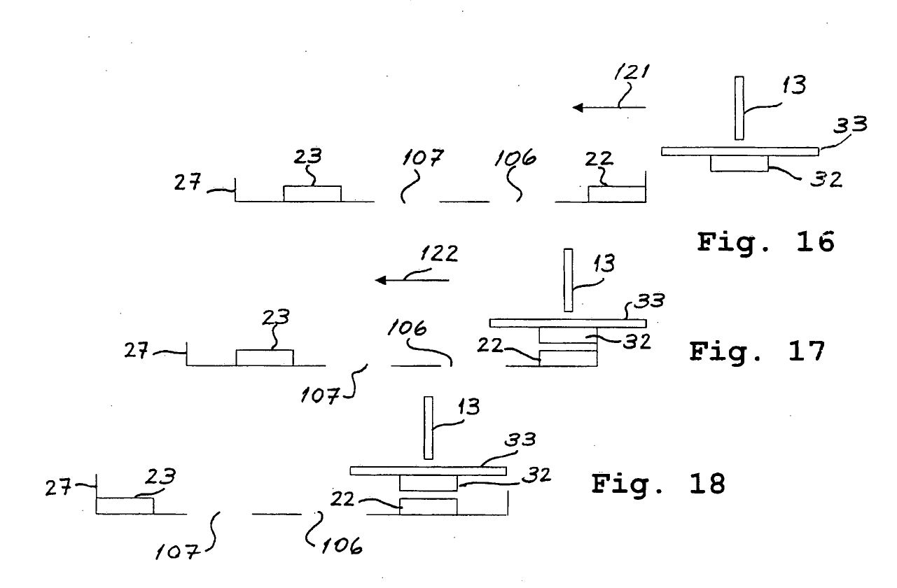

When transport device 31 is used for bringing pipetting needle to a pipetting position, permanent magnet 32 attached to lower plate 33 of transport device 31 is used for moving slide element 21 of closure mechanism 17 (described above with reference to FIGS. 10 to 14) as described hereinafter with reference to FIGS. 16 to 22.

FIGS. 16 to 22 illustrate various positions of magnet 32 attached to transport device 31 of pipetting needle 13 with respect to the magnets 22, 23 attached to slide element 21 of closure mechanism 17 of cover 14 of the central part of the apparatus shown by FIGS. 1, 2 and 8.

FIG. 16 shows an initial position of magnet 32 with respect to magnets 22 and 23 on slide element 21 when the position of pipetting needle 13 with respect to closure mechanism 17 is as shown in FIG. 8, and the position of slide element 21 with respect to the lower plate 27 of closure mechanism 17 is as shown in FIG. 13. In this position the body of slide element 21 closes pipetting openings 15 and 16.

Starting from the position of pipetting needle 13 shown in FIG. 16, pipetting needle 13 is moved by transport device 31 in the sense indicated by an arrow 121 in FIG. 16 towards a pipetting position.

On its way towards a pipetting position, pipetting needle 13 reaches the position shown by FIG. 17 at which magnet 32 is in face of magnet 22 on slide element 21. Magnets 22 and 32 are of opposite polarity. Therefore, when pipetting needle 13 is moved further in the sense indicated by an arrow 122 in FIG. 17, magnet 32 pulls magnet 22 and thereby moves slide element 21 in the sense of arrow 122 until slide element 21 reaches the position shown in FIG. 18, which is the position of slide element 21 with respect to the lower plate 27 of closure mechanism 17 shown in FIG. 14. In this position of slide element 21 openings 24, 25 thereof are aligned with pipetting openings 15, 16 of cover 14, which are thus open and allow insertion of pipetting needle 13 therethrough.

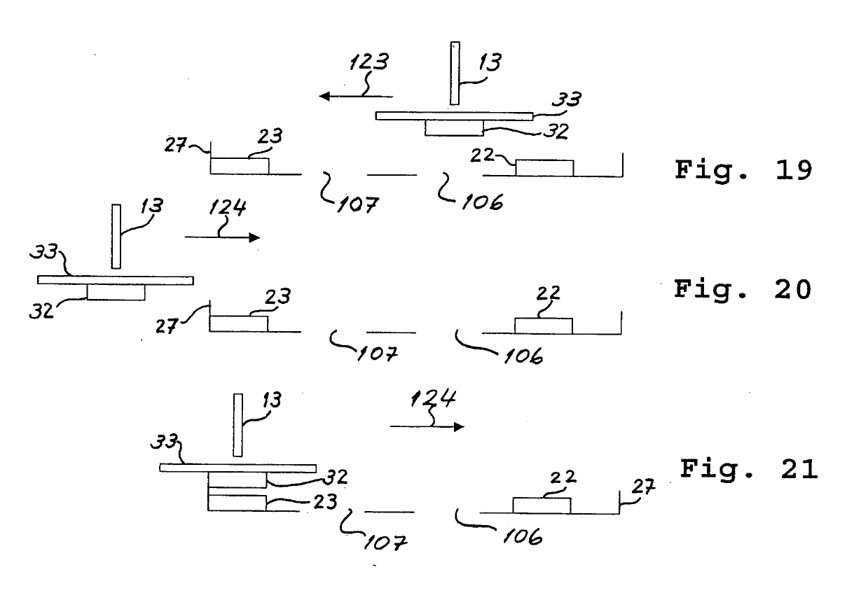

When pipetting needle 13 is moved further in the sense indicated by an arrow 122 in FIG. 17, magnet 32 reaches the pipetting position shown in FIG. 19. Magnet 22 cannot be pulled further by magnet 32, because slide element abuts lower plate 27 and cannot move further in that sense.

Pipetting needle 13 is moved further in the sense indicated by arrow 123 shown in FIG. 19 to an end position shown by FIG. 20. Pipetting needle 13 is then moved in the sense indicated by arrow 124 shown in FIG. 20.

When pipetting needle 13 is at the position shown by FIG. 17 magnets 22 and 32 aligned with each other. When pipetting needle 13 is moved further in the sense indicated by arrow 122 in FIG. 17, magnet 32 pulls magnet 23 and thereby slide element 21 into a position where openings 106 and 107 are open. When pipetting needle 13 reaches a position at which it is aligned with opening 106 (as shown in FIG. 19), pipetting needle 13 is lowered by transport device 31, passes through opening 106 of lower plate 27 of closure mechanism 17, enters into a reagent container the upper open end of which is aligned with opening 106 and aspires an aliquot of reagent from that reagent container.

An alternative example for the motion of the pipetting needle is described hereinafter. In this example, further movement of pipetting needle 13 in the sense of arrow 123 in FIG. 19 brings pipetting needle 13 to a second pipetting position at which pipetting needle 13 is aligned with opening 107 of the lower plate 27 of closure mechanism 17. With pipetting needle 13 in this position a second pipetting operation similar to the above described with reference to FIG. 19 is effected in another reagent container.

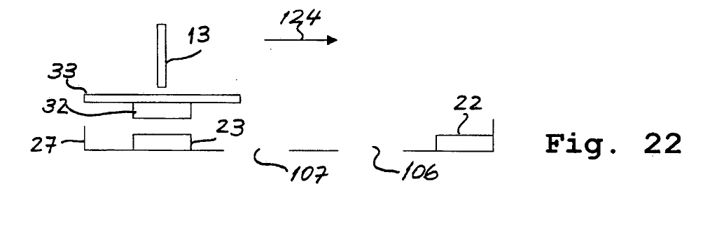

After this second pipetting operation pipetting needle is moved further in the sense of arrow 123 in FIG. 19 until it takes the position shown in FIG. 20. Transport device 31 moves then pipetting needle 13 from its position shown in FIG. 20 in the sense of arrow 124 in FIG. 20, along this motion magnet 32 reaches the position shown in FIG. 21. As transport device 31 moves then pipetting needle 13 further in the sense of arrow 124, magnet 32 pulls magnet 23 and thereby moves slide element 21 in the sense of arrow 124 until slide element 21 reaches the position shown in FIG. 22, which is the position of slide element 21 with respect to the lower plate 27 of closure mechanism 17 shown in FIG. 13. In this position the body of slide element 21 closes pipetting openings 15 and 16.

After this last operation transport device 31 moves pipetting needle further in the sense of arrow 124 and brings pipetting 13 to its initial position shown in FIG. 16.

The course of action described above with reference to FIGS. 16 to 22 shows that with the apparatus described with reference to FIGS. 1-15, the magnet 32 attached to transport device 31 of the pipetting needle cooperates with the magnets 22, 23 of slide element 21 of closure mechanism 17 for opening pipetting openings 15, 16 just before pipetting needle reaches a pipetting position and for closing pipetting openings 15, 16 just after pipetting needle is withdrawn from a pipetting position and is moved back to its initial position. This operation of the closure mechanism 17 ensures that pipetting openings 15, 16 are opened just over short time intervals necessary for taking reagent aliquots from reagent containers with the pipetting needle and are closed the rest of the time. It is to be appreciated that in this manner the amount of water vapor condensation in the reagent containers and in the interior of the housing 116 (of reagent container assembly 93) where the reagent containers are lodged is considerably reduced.

It is to be appreciated that for the embodiment of closure mechanism 17 described with reference to FIGS. 8 to 22, the actuation mechanism of the closure mechanism 17 is very simple, and does not require a dedicated drive mechanism for moving slide element 21, because magnet 32 attached to transport device 31 of pipetting needle 13 is used for that purpose. Moreover slide element 21 is moved back and forth only by magnetic forces. Slide element 21 is thus not subject to any mechanical stress of the kind to expected if slide element would be moved by drive means mechanically connected with it.

An alternative embodiment of closure mechanism 17 for the apparatus described above with reference to FIGS. 1 to 7 is described hereinafter with reference to FIGS. 23 to 28.

FIG. 23 shows a bottom plan view of a part of the alternative embodiment of closure mechanism 17 of the pipetting openings 15 and 16 in cover 14 of the central part of the analyzer of FIGS. 1 and 8. In this alternative embodiment, closure mechanism 17 is mounted on the inner surface of cover 14, e.g. by means of screws. A thermal insulation plate 131 is located between the inner surface of cover 14 and closure mechanism 17.

As shown by FIG. 23, in this embodiment, closure mechanism 17 comprises at first pair of slide elements 41, 42 for closing and opening pipetting opening 15 and a second pair of slide elements 43, 44 for closing and opening pipetting opening 16.

Slide elements 41, 42 are held in a first position shown in FIG. 23 by springs 51, 52 which exert forces of opposite senses on slide elements 41, 42 and press them against each other. In the same way, Slide elements 43, 44 are held in a first position shown in FIG. 23 by springs 53, 54 which exert forces of opposite senses on slide elements 43, 44 and press them against each other.

The positions of slide elements 41, 42, 43, 44 in FIG. 23 correspond to a first state of the second embodiment of closure mechanism 17. When slide elements 41, 42, 43, 44 are in the positions shown in FIG. 23, they close pipetting openings 15 and 16.

Each of the slide elements 41, 42, 43, 44 shown in FIG. 23 has a plane upper surface and a pin 61, 62, 63, 64 respectively which extends upwards in a direction which is perpendicular to the upper surface of slide element 41, 42, 43, 44.

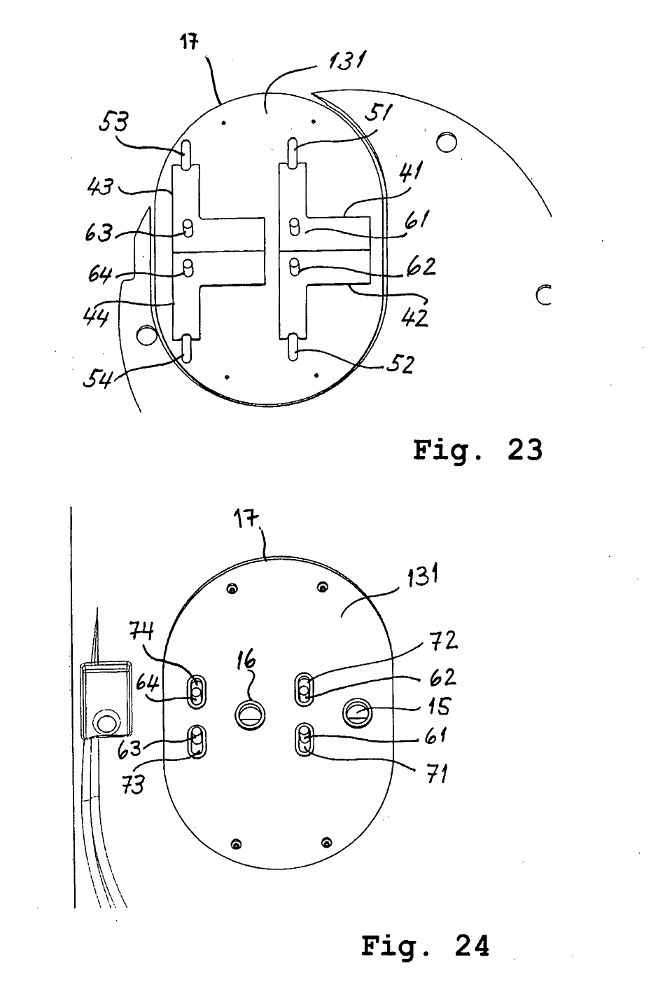

As shown by FIG. 24, cover 14 of the central part of the analyzer of FIGS. 1 and 8 has elongated openings 71, 72, 73, 74 each of which allows passage of a portion of one of slide pins 61, 62, 63, 64 therethrough and motion of the pin portion along the elongated opening 71, 72, 73, 74 respectively. The end portion of each of pins 61, 62, 63, 64 extends beyond the upper surface of movable cover 14.

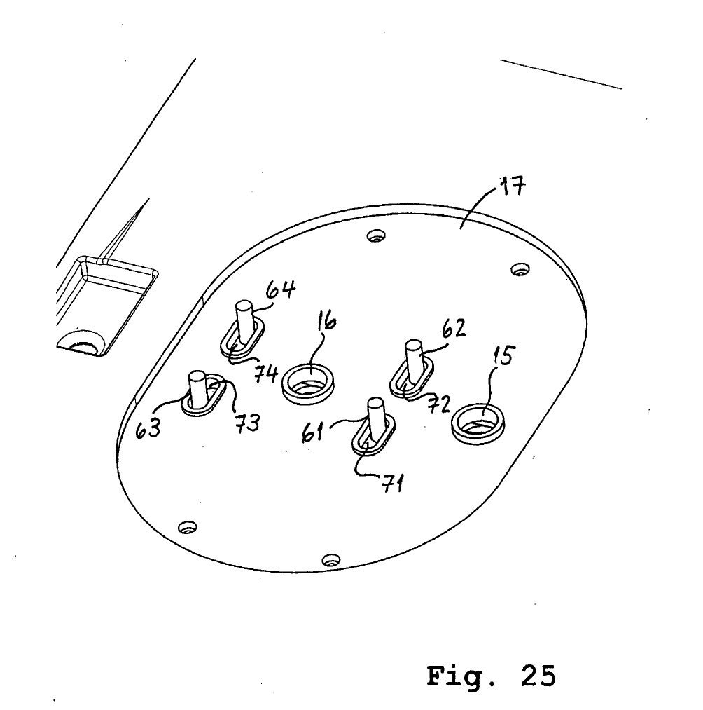

FIG. 25 shows a perspective view of cover 14 shown in FIG. 24

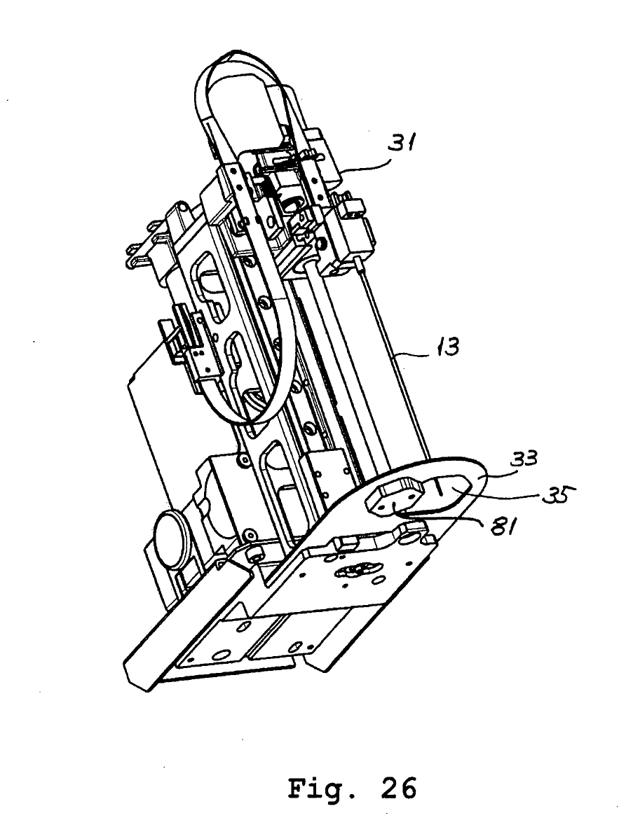

FIG. 26 shows a perspective view of an alternative embodiment of the actuation mechanism as a part of an embodiment of transport device 31 which transports pipetting needle 13 and which is suitable for actuating the alternative embodiment of closure mechanism 17. FIG. 26 shows in particular that this embodiment of transport device 31 carries a cam 81 as the actuation mechanism. As shown, the cam 81 is attached to the outer surface of plate 33 which is part of transport device 31 and has opening 35 which allows passage of pipetting needle 13 therethrough.

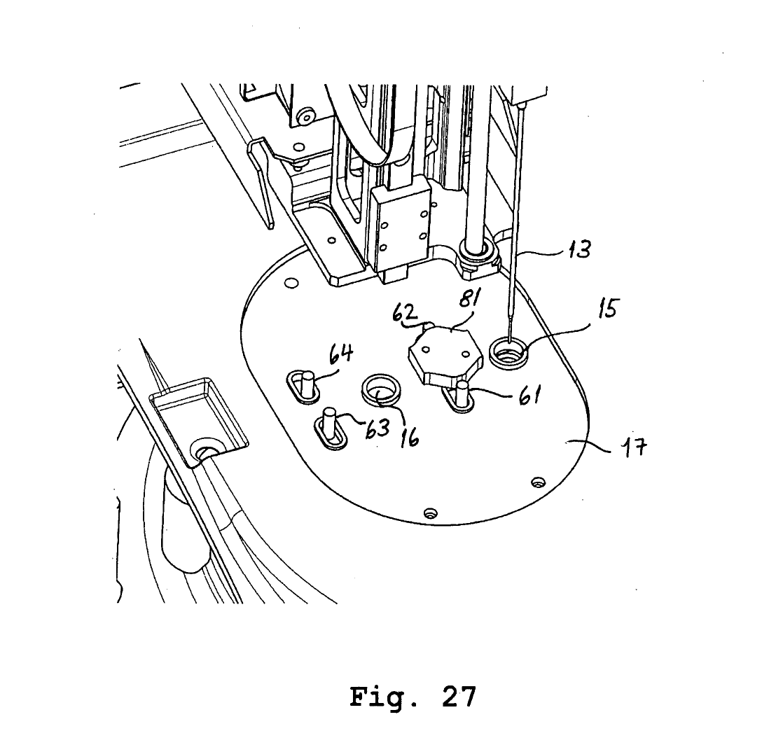

FIGS. 26 and 27 show the shape of cam 81 which is suitable for actuating the illustrated embodiment of closure mechanism 17. For this purpose, pins 61, 62, 63, 64 of the slide elements 41, 42, 43, 44, cam 81, the pipetting needle 13 and the path followed by the pipetting needle 13 when it is moved by the transport device 31 thereof are so arranged and configured with respect to each other that when transport device 31 moves pipetting needle 13 towards at least one pipetting position, cam 81 contacts the upper end portions of the slide pins 61 and 62 and shortly thereafter, contacts also the upper end portions of the slide pins 63 and 64, pushes those pins apart against the forces exerted by springs 51, 52, 53, 54, and thereby brings slide elements 41, 42 and 43, 44, respectively, into a second position, which corresponds to a second state of the shown embodiment of closure mechanism 17. It is to be appreciated that when transport device 31 moves pipetting needle 13 away from the at least one pipetting position, cam 81 moves away from the upper end portions of slide pins 61, 62 and 63, 64, respectively, and the springs 51, 52 and 53, 54, respectively, push slide elements 41, 42 and 43, 44, respectively, against each other and bring them back into their first position.

When cam 81 brings slide elements 41, 42 to their second position shown by FIG. 27, pipetting opening 15 is open. In a similar way, when slide elements 43, 44 are in their second position, i.e. pushed apart by cam 81, pipetting opening 16 is open.

FIG. 27 shows how cam 81 cooperates with pins 61, 62 and 63, 64, respectively, of the slide elements 41, 42 and 43, 44, respectively, for displacing those elements to positions where they leave pipetting openings 15 and 16 open.

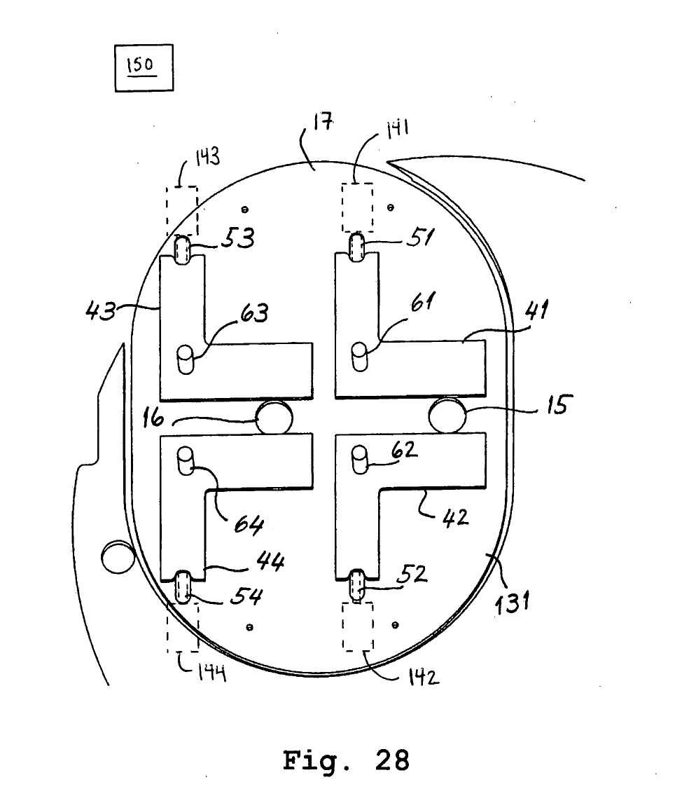

FIG. 28 shows a bottom plan view of a part of the alternative embodiment of closure mechanism 17 with the slide elements 41, 42, 43, 44 in positions at which they leave pipetting openings 15 and 16 open.

The operation of the alternative embodiment of closure mechanism 17 described above with reference to FIGS. 23 to 28 is such that cam 81 attached to transport device 31 of the pipetting needle cooperates with the pins 61, 62, and 63, 64, respectively, of slide elements 41, 42, and 43, 44, respectively, for opening pipetting openings 15, 16 just before pipetting needle reaches a pipetting position and for closing pipetting openings 15, 16 just after pipetting needle is withdrawn from a pipetting position and is moved further to another pipetting position or back to its initial position. This operation of the closure mechanism 17 ensures that pipetting openings 15, 16 are opened just over short time intervals necessary for taking reagent aliquots from reagent containers with the pipetting needle and are closed the rest of the time. It is to be appreciated that with the above described embodiment of the present invention the amount of water vapor condensation in the reagent containers and in the interior of the housing where the reagent containers are lodged is considerably reduced.

It is further to be appreciated that the embodiment of closure mechanism 17 described with reference to FIGS. 23 to 28, the actuation mechanism of the closure mechanism 17 is very simple, and does not require a dedicated drive mechanism for moving each of slide elements 41, 42, 43, 44, because cam 81 attached to transport device 31 of pipetting needle 13 is used for that purpose.

Yet another alternative embodiment of closure mechanism 17 for the apparatus described above with reference to FIGS. 1 to 7 is a modification of the embodiment of closure mechanism 17 described above with further reference to FIGS. 23-28. In this further alternative embodiment, closure mechanism 17 comprises solenoid actuators 141, 142, 143, 144 (represented as optional components in FIG. 28) which function as the actuation mechanism for actuating each of the slide elements 41, 42, 43, 44, respectively. In this alternative embodiment, each of the slide elements 41, 42, 43, 44 is connected to the movable part of one of the solenoid actuators 141, 142, 143, 144, receptively, and in which the solenoid actuators are controlled by a controller 150 which controls the operation of transport device 31 of pipetting needle 13. In this embodiment of closure mechanism 17, slide elements 41, 42 and 43, 44, respectively, are held in a first position by springs, e.g. springs 51, 52, 53, 54, of the solenoid actuators 141, 142, 143, 144, respectively, in their non-operated state, and these springs exert forces of opposite senses on slide elements 41, 42 and 43, 44, respectively, and press them against each other. The first position of the slide elements 41, 42 and 43, 44, respectively, corresponds to the first state of the embodiment of closure mechanism 17. In this alternative embodiment of closure mechanism 17, the controller 150, which control the operation of the solenoid actuators 141, 142, 143, 144, and the operation of transport device 31 of pipetting needle 13, is so configured that when the transport device 31 moves the pipetting needle 13 towards a pipetting position and the latter reaches that position the controller 150 operates the solenoid actuators 141, 142, and 143, 144, respectively, and these solenoid actuators pull two of the slide elements 41, 42, and 43, 44, respectively, apart against the forces exerted by the springs of the solenoid actuators, e.g. springs 51, 52, and 53, 54, respectively, and bring the slide elements 41, 42, and 43, 44, respectively, into a second position, the second position of the slide elements 41, 42, and 43, 44, respectively, corresponding to the second state of closure mechanism 17. It is to be appreciated that when transport device 31 moves the pipetting needle 13 away from a pipetting position the controller 150 leaves the solenoid actuators 141, 142, and 143, 144, respectively, non-operated and the springs of the solenoid actuators, e.g., springs 51, 52, and 53, 54, respectively, push two of the slide elements 41, 42, and 43, 44, respectively, against each other and bring them back into their first position, the pipetting opening 15, 16 being closed when slide elements 41, 42, and 43, 44, respectively, being in their first position and the pipetting opening 15, 16 being open when slide elements 41, 42, and 43, 44, respectively, are in their second position.

The operation of the alternative embodiment of closure mechanism 17 described above is such that the controller 150, which controls transport device 31, also controls the above mentioned solenoid actuators 141, 142, 143, 144 in such a way that pipetting openings 15, 16 are opened just before pipetting needle reaches a pipetting position and pipetting openings 15, 16 are closed just after pipetting needle is withdrawn from a pipetting position and is moved further to another pipetting position or back to its initial position. This operation of this alternative embodiment of closure mechanism 17 ensures that pipetting openings 15, 16 are opened just over short time intervals necessary for taking reagent aliquots from reagent containers with the pipetting needle and are closed the rest of the time. It is to be appreciated that in this manner, as in all the other above described embodiments of the present invention, the amount of water vapor condensation in the reagent containers and in the interior of the housing where the reagent containers are lodged is considerably reduced.

Although various preferred embodiments of the invention have been described using specific terms, such description is for illustrative purposes only, and it is to be understood that changes and variations may be made without departing from the scope of the following claims.

What is claimed is:

1. A clinical chemistry analytical apparatus for automatically analyzing a plurality of samples of biological fluids, wherein aliquots of said samples are mixed with aliquots of selected reagent liquids in reaction cuvettes for forming sample-reagent-mixtures contained in a plurality of reaction cuvettes, said apparatus comprising:
an array of reagent containers and an array of reaction cuvettes, each of said reagent containers and reaction cuvettes having an opening at its upper end;
an automatic pipetting unit having a pipetting needle for taking an aliquot of reagent from one of said reagent containers and for delivering said aliquot into one of said reaction cuvettes, said automatic pipetting unit having a transport device for moving said pipetting needle to at least one pipetting position, said transport device being adapted for moving said pipetting needle along a first axis which extends in vertical direction and along a second axis which is perpendicular to said first axis;
a movable cover covering a chamber in which reagent containers are stored, said cover having a closed position at which it closes said chamber, said cover having at least one pipetting opening which allows insertion of said pipetting needle therethrough, the center of said at least one pipetting opening being located at said at least one pipetting position;
a closure mechanism mounted on said cover, said closure mechanism being adapted for being brought into a first state and into a second state, said at least one pipetting opening being closed when said closure mechanism is in said first state and said at least one pipetting opening being open when said closure mechanism is in said second state;
a conveyor configured to automatically transport each of said reagent containers to a pipetting position, at which the opening at the upper end of the reagent container is aligned with said at least one pipetting opening of said cover; and
an actuation mechanism configured to automatically actuate said closure mechanism to bring said closure mechanism into the second state before introducing said pipetting needle through said at least one pipetting opening and to automatically actuate said closure mechanism to bring said closure mechanism into the first state after withdrawal of said pipetting needle from said at least one pipetting opening,
wherein said actuation mechanism is adapted for being actuated by a displacement of said transport device associated with the motion thereof that moves said pipetting needle along said second axis to said at least one pipetting position, and respectively away from said at least one pipetting position.

2. An apparatus according to claim 1, wherein
said closure mechanism comprises a slide element which has a first permanent magnet attached thereto and which has at least one opening which allows insertion of the pipetting needle therethrough,
said slide element being in a first position when said closure mechanism is in said first state and in a second position when said closure mechanism is in said second state,
said at least one opening of the slide element being aligned with said at least one pipetting opening when said slide element is in said second position and said slide element closing said at least one pipetting opening when said slide element is in said first position,
a second permanent magnet is attached to said transport device of the pipetting needle, and
said at least one opening of the slide element, said first permanent magnet, said second permanent magnet, said pipetting needle and the path followed by the pipetting needle when it is moved by said transport device thereof are so arranged with respect to each other that
when the transport device moves the pipetting needle towards said at least one pipetting position said second permanent magnet passes close to said first permanent magnet and exerts on it a magnetic force which pulls the slide element towards its second position, and
when the transport device moves the pipetting needle away from said at least one pipetting position said second permanent magnet passes close to said first permanent magnet and exerts on it a magnetic force which pulls the slide element towards its first position.

3. An apparatus according to claim 1, wherein
said closure mechanism comprises at least one pair of slide elements which are held in a first position by springs which exert forces of opposite senses on the slide elements and press them against each other, said first position of the slide elements corresponding to said first state of said closure mechanism,
each of the slide elements of said at least one pair having a plane upper surface and a pin which extends upwards in a direction which is perpendicular to said upper surface of the slide element,
said movable cover having elongated openings each of which allows passage of a part of one of said pins therethrough and motion of said pin along said elongated opening, the end portion of said pin extending beyond the upper surface of said movable cover,
wherein said actuation mechanism is a cam attached to said transport device of the pipetting needle,
said pins of the slide elements, said cam, said pipetting needle and the path followed by the pipetting needle when it is moved by said transport device thereof are so arranged and configured with respect to each other that
when the transport device moves the pipetting needle towards said at least one pipetting position, said cam contacts the upper end portions of said pins and pushes them apart against the forces exerted by the springs and thereby brings the slide elements into a second position, said second position of the slide elements corresponding to said second state of said closure mechanism, and
when the transport device moves the pipetting needle away from said at least one pipetting position said cam moves away from the upper end portions of the slide pins and the springs push the slide elements (against each other and bring them back into their first position,
said at least one pipetting opening being closed when said slide elements are in their first position and said at least one pipetting opening being open when said slide elements are in their second position.

4. An apparatus according to claim 1, wherein
said actuation mechanism is at least one pair of solenoid actuators controlled by a controller which control the operation of said transport device of the pipetting needle, and
at least one pair of slide elements each of which is connected to the movable part of one of said solenoid actuators,
said slide elements being held in a first position by springs of said solenoid actuators in their non-operated state, said springs exerting forces of opposite senses on the slide elements and pressing them against each other, said first position of the slide elements corresponding to said first state of said closure mechanism,
said controller which control the operation of said at least two solenoid actuators and the operation of said transport device of the pipetting needle being so configured that
when the transport device moves the pipetting needle towards said at least one pipetting position and the latter reaches said position the controller operate the solenoid actuators and these pull two of the at least one pair of slide elements apart against the forces exerted by the springs of the solenoid actuators and bring the slide elements into a second position, said second position of the slide elements corresponding to said second state of said closure mechanism, and
when the transport device moves the pipetting needle away from said at least one pipetting position said controller leave said solenoid actuators non-operated and the springs of the solenoid actuators push two of the at least one pair of slide elements against each other and bring them back into their first position,
said at least one pipetting opening being closed when said slide elements are in their first position and said at least one pipetting opening being open when said slide elements are in their second position.

5. An apparatus according to claim 1, wherein said cover of said chamber is an air-tight closure thereof when it is in its closed position.

6. An apparatus according to claim 1, wherein said at least one pipetting opening is just large enough to allow insertion of said pipetting needle therethrough.

7. An apparatus according to claim 1, wherein said actuation mechanism is further configured to automatically bring said closure mechanism into the second state immediately before introducing said pipetting needle through said at least one pipetting opening and bring said closure mechanism into the first state immediately after withdrawal of said pipetting needle from said at least one pipetting opening.

8. An apparatus according to claim 1, wherein said actuation mechanism is configured to actuate said closure mechanism only by magnetic forces.
